(19) United States
(12) Patent Application Publication
(10) Pub. No.: US 2023/0357607 A1
(43) Pub. Date: Nov. 9, 2023

(54) Carbohydrate-Based Formaldehyde-Free Binder for Engineered Wood Products

(71) Applicant: Humayun Mandal, Warwick, RI (US)

(72) Inventor: Humayun Mandal, Warwick, RI (US)

(21) Appl. No.: 18/355,303

(22) Filed: Jul. 19, 2023

Related U.S. Application Data
(63) Continuation-in-part of application No. 16/301,370, filed on Nov. 13, 2018, now abandoned.

(51) Int. Cl. C09J 105/00; C09J 11/08; C09J 11/04; C09J 11/06; B27N 3/00

(52) U.S. Cl. CPC C09J 105/00; C09J 11/08; C09J 11/04; C09J 11/06; B27N 3/002

(57) ABSTRACT

Formaldehyde-free aqueous binder compositions, their preparation, and their use to prepare engineered composite products, where the aqueous binder has at least some solids content, the aqueous binder including a carbohydrate polymer in an amount of about 5% to about 90% of the solids content, by weight; a copolymer of an alkenyl aromatic with at least one of an acrylate or diene in an amount of about 1% to about 40% of the solids content, by weight; and urea in an amount of about 2% to about 90% of the solids content, by weight.

### CROSS-REFERENCE TO RELATED PRIOR APPLICATIONS

This Application is a Continuation-in-Part (CIP) of pending U.S. Nonprovisional Application Ser. No. 16/301,370, filed on Nov. 13, 2018, under 35 U.S.C. 371(c), which claims the benefit of International Application No. PCT/US2017/033366 designating the United States, filed on May 18, 2017, which claims the benefit of U.S. Provisional Application No. US2016/62338090P, filed on May 18, 2016.

### TECHNICAL FIELD

The present disclosure relates to binder compositions for engineered lignocellulose-based products, and more particularly to formaldehyde-free binder compositions for the manufacture of engineered wood products.

### BACKGROUND

Formaldehyde based amino resins are widely used as adhesives for the manufacture of particleboard, medium density fiberboard, hardwood plywood and similar wood products because they are inexpensive, provide colorless glue lines and give excellent physical and mechanical properties upon curing. These adhesives, however, are known to hydrolyze and release formaldehyde gradually into the atmosphere over time. Formaldehyde vapor has been classified by the International Agency for Research on Cancer (IARC) as a known human carcinogen and is hazardous to human health, causing eye and throat irritations as well as respiratory discomfort. Because the composite wood panels manufactured with these adhesives are used primarily in the interior of residential and commercial buildings, they have a significant impact on interior air quality. There is a growing concern about the emissions of formaldehyde during the manufacture and usage of wood articles due to its potential health risk. The regulations regarding the level of free formaldehyde during and after the manufacture of the wood articles are getting more stringent with time in almost all sectors of wood adhesive applications. The California Air Resources Board (CARB), a division of California Environmental Protection Agency, has already implemented Phase II emission standard on formaldehyde emissions from wood composite boards which is one of the world's toughest standards on formaldehyde emissions. This rule applies to particleboard, medium density fiberboard, hardwood plywood and all products (such as cabinets, furniture, flooring, countertops, doors, windows, decorative household items, etc.) made with these products. Manufacturers of these products must label and certify that they are CARB P II compliant.

Furthermore, California's rule governing formaldehyde emissions from composite wood panels would be implemented throughout the US under a pair of proposed rules announced on May 29, 2013, by the US Environmental Protection Agency (EPA). EPA's proposed rules align, where practical, with the requirements for composite wood products set by CARB, putting in place the formaldehyde emissions standard for composite wood products sold, supplied, offered for sale or manufactured not only in California but all throughout the United States. EPA's national rules will also encourage an ongoing industry trend toward switching to formaldehyde-free adhesives in the composite wood products market. Therefore, there is an ever-increasing need for formaldehyde-free binders for wood which would give properties comparable to or better than the existing formaldehyde-based binders.

Relevant references on carbohydrate-based formaldehyde-free binders for wood are described in the following paragraphs.

U.S. Pat. No. 4,107,379 describes the application of a mixture of sugar solution and an inorganic acid onto the surfaces of the lignocellulosic material to be bonded, followed by heating and pressing until the carbohydrates are transformed into furan-type compounds which act as adhesives.

U.S. Pat. No. 4,692,478 describes a formaldehyde-free binder for particleboard and plywood prepared of carbohydrate raw material. However, the very acidic nature of the reaction and the fact that the reaction needs to be performed under high pressure makes the process hazardous.

U.S. Pat. No. 4,944,823 discloses a binder composition constituting a mixture of an isocyanate and a sugar or starch. This system, however, is exceptionally slow curing and not commercially attractive.

Int. Pat. WO201298749 A1 describes the manufacture of particleboard or fiberboard using a plant-derived product that has been segmented or formed into fibers. However, the cure temperature required is comparatively higher and the cure time is significantly longer than current manufacturing methods for particleboard and medium-density fiberboard.

U.S. Pat. No. 6,822,04262 describes a saccharide-based adhesive for composite wood products, other lignocellulosic materials, and non-cellulosic materials. However, the shelf-life of the one-part composition is still very limited.

European Pat. EP2457954 A1 discloses a binder composition based on a reducing sugar and/or an aldehyde containing sugar for the manufacture of composite wood boards, for example particleboards, oriented strand boards and wood fiber boards. Bond strengths over standard value were obtained only at significantly higher temperatures and longer press times than typical commercial processes.

Previously described formaldehyde-free adhesives have suffered from a number of disadvantages, requiring extended curing times, new or updated equipment, or they release volatile toxic compounds other than formaldehyde. In addition, some of them require highly acidic conditions, increasing the corrosive wear on production equipment. What is needed is a more efficient, non-toxic, and environmentally benign adhesive system for composite wood products manufacture.

### SUMMARY

The present disclosure provides formaldehyde-free binder compositions, methods for their preparation, and methods of manufacturing engineered composite products using the binder compositions.

In some aspects, the disclosure may provide curable formaldehyde-free aqueous binder compositions, where the binder compositions include at least some solids content, including a carbohydrate polymer in an amount of about 5% to about 90% of the solids content, by weight; a copolymer of an alkenyl aromatic with at least one of an acrylate and a diene in an amount of about 1% to about 40% of the solids content, by weight; and urea in an amount of about 2% to about 90% of the solids content, by weight.

In another aspect, the disclosure may provide curable formaldehyde-free aqueous binders for lignocellulosic materials, where the binder compositions have at least some solids content, including a carbohydrate polymer in an amount of about 5% to about 90% of the solids content, by weight; a copolymer of an alkenyl aromatic with at least one of an acrylate or a diene in an amount of about 1% to about 40% of the solids content, by weight; a partially and/or fully hydrolyzed polyvinyl alcohol in an amount of about 0.5% to about 10% of the solids content, by weight; urea in an amount of about 2% to about 90% of the solids content, by weight; and additionally may include one or more of a polyol in an amount of about 0.5% to about 40% of the solids content, by weight; a defoaming agent in an amount of about 0.1% to about 15% of the solids content, by weight; a carboxylic acid in an amount of about 0.5% to about 20% of the solids content, by weight; an alkali metal carboxylate in an amount of about 0.5% to about 20% of the solids content, by weight; an alkali metal hydroxide in an amount of about 0.1% to about 30% of the solids content, by weight; and a release agent in an amount of about 0.1% to about 20% of the solids content, by weight.

In another aspect, the disclosure may provide a method of making a curable formaldehyde-free aqueous binder, including the steps of fully dissolving polyvinyl alcohol powder in water at 85-95° C., cooling the water temperature down to 65-70° C., adding urea at 65-70° C. until it is fully dissolved and then lowering the water temperature to 35-40° C.; adding a carbohydrate polymer at 35-40° C.; and adding an emulsion of a copolymer of a styrene and at least one of an acrylate and an alkadiene to the polyvinyl alcohol, urea and carbohydrate polymer solution to form a stable carbohydrate, polyvinyl alcohol and urea dispersion.

In another aspect, the disclosure may provide a method of manufacturing an engineered composite product, including the steps of mixing a curable formaldehyde-free aqueous binder according to the present disclosure with an appropriate crosslinking agent to form an adhesive; applying the mixed adhesive to a lignocellulosic material; heating the mixed adhesive and lignocellulosic material; and compressing the combined adhesive and lignocellulosic materials to form an engineered composite product.

The features, functions, and advantages of the disclosed materials and methods may be achieved independently in various aspects of the present disclosure or may be combined in yet other aspects further details of which can be seen with reference to the following description and drawings.

### BRIEF DESCRIPTION OF THE DRAWINGS

FIG. 1 is a flowchart depicting an illustrative method of preparing a curable formaldehyde-free aqueous binder, according to the present disclosure.

FIG. 2 is a flowchart depicting an illustrative method of manufacturing an engineered composite product, according to the present disclosure.

FIG. 3 is a plot illustrating Internal Bond Strengths of particleboards manufactured using carbohydrate polymer-based adhesives versus neat pMDI binders.

FIG. 4 is a plot illustrating Modulus of Rupture for particleboards manufactured using carbohydrate polymer-based adhesives versus neat pMDI binders.

FIG. 5 is a plot illustrating Modulus of Elasticity of particleboards manufactured using carbohydrate polymer-based adhesives versus neat pMDI binders.

FIG. 6 is a plot illustrating Percent Thickness Swell of particleboards manufactured using carbohydrate polymer-based adhesives versus neat pMDI binders.

### DETAILED DESCRIPTION

The present disclosure is directed to binder compositions that, when combined with an appropriate crosslinking agent, form a curable formaldehyde-free adhesive that is particularly well-suited for the manufacture of engineered composite products, and in particular the manufacture of engineered wood products.

The disclosed aqueous binder compositions may include a carbohydrate polymer, a copolymer of an alkenyl aromatic with at least one of an unsaturated acrylate and an alkadiene, a partially and/or fully hydrolyzed polyvinyl alcohol and urea. The binder compositions may be formulated so that upon combination with a crosslinking agent, the compositions form a strong adhesive suitable for the manufacture of high-quality lignocellulose-based engineered products that nevertheless are not prone to releasing formaldehyde due to hydrolysis over time.

In addition to the carbohydrate polymer, the copolymer of alkenyl aromatic with one of an unsaturated acrylate and an alkadiene, a partially and/or fully hydrolyzed polyvinyl alcohol and urea, the disclosed binder compositions may also include one or more polyols, defoaming agents, carboxylic acids, alkali metal carboxylates, alkali metal hydroxides, halide, sulfate and nitrate salts of ammonium and aluminum, glutaraldehyde sodium bisulfite addition compound, glyoxal sodium bisulfite addition compound, release agents, or other components and adjuncts.

The aqueous binder compositions disclosed herein may typically include a certain amount of solids as a function of the amount of solids contained by each component of the binder composition. These binder solids (also referred to as “non-volatiles percent”) of the binder composition may range from 20 weight percent to 80 weight percent. In some aspects, the binder solids may range from 40 weight percent to 80 weight percent of the binder composition. In other aspects, the binder solids content may range from 45 weight percent to 80 weight percent.

### The Carbohydrate Polymer

Any carbohydrate polymer useful in the recited binder compositions is a suitable carbohydrate polymer for the purposes of this disclosure. In one aspect of the compositions, the carbohydrate polymer may be derived from a renewable source of such carbohydrate polymers. For example, carbohydrates may be derived from plant sources such as corn or maize (including waxy corn), sugar cane, potatoes, sweet potatoes, rice (including waxy rice), or cereal grains (such as wheat or barley), among others. The carbohydrate polymer may be obtained from one or more such sources and may be used in any combination thereof.

The carbohydrate polymer may be a monosaccharide, disaccharide, oligosaccharide, or polysaccharide, or any combination thereof.

The carbohydrate polymer may be selected to have a dextrose equivalent (DE) number ranging from 2 to 20. The dextrose equivalent of a carbohydrate is a measure of the amount of reducing sugars present in the carbohydrate and is typically expressed as a percentage relative to the value for pure dextrose (on a dry basis). The dextrose equivalent value may provide an indication of the average degree of polymerization for the carbohydrate polymer.

An amount of the selected carbohydrate polymer(s) may be chosen to result in a concentration of the carbohydrate polymer in the resulting curable aqueous binder composition of at least 5 weight percent. In some aspects, the concentration is 10 weight percent to 90 weight percent. In other aspects, the concentration range may be 15 weight percent to 80 weight percent, wherein the weight percent is based on the weight of the binder solids in the resulting curable aqueous binder composition.

### Copolymer Emulsion

The curable aqueous binder composition may include a copolymer of aromatic and aliphatic unsaturated monomers, that is typically commercially available as a copolymer emulsion. The copolymer may be prepared using monomers having an unsaturated functionality, such as alkenyl aromatics, acrylates, and dienes, among others.

Suitable examples of alkenyl aromatic monomers may include styrenes, such as for example methyl styrenes, dimethyl styrenes, ethyl styrenes, diethyl styrenes, t-butyl styrenes, phenyl styrenes, and combinations thereof. In a preferred aspect of the binder composition, the alkenyl aromatic monomer is styrene.

Suitable examples of unsaturated acrylate monomers useful for polymerizing with the styrene monomers may include acrylic acid; methacrylic acid; and alkyl esters of acrylic and methacrylic acid such as methyl acrylate, methyl methacrylate, ethyl methacrylate, propyl acrylate, propyl methacrylate, n-butyl acrylate, n-butyl methacrylate, iso-butyl acrylate, iso-butyl-methacrylate, octyl methacrylate; and alkyl acrylates such as ethyl acrylate, methoxymethyl methacrylate, n-butoxyethyl methacrylate; and combinations thereof, among others.

The styrene-acrylate copolymer emulsion may have a viscosity up to 3000 cPs. In some aspects, the styrene-acrylate copolymer emulsion may have a viscosity in the range of 30 cPs to 1500 cPs, and in other aspects, the styrene-acrylate copolymer emulsion may have a viscosity in the range of 50 cPs to 1000 cPs.

The styrene-acrylate copolymer emulsion may include solids in an amount up to 70%. In some aspects, the styrene-containing emulsion has solids in an amount from 35% to 65%, and in other aspects, the styrene-acrylate copolymer emulsion has solids in an amount from 40% to 60%.

The concentration of the styrene-acrylate copolymer emulsion in the resulting curable aqueous binder composition is at least 1 weight percent. In some aspects, the concentration of the copolymer emulsion is 2 weight percent to 50 weight percent of the resulting binding composition. In other aspects, the concentration range is 5 weight percent to 40 weight percent. For each aspect the weight percent of the copolymer emulsion is based on the weight of the solids content in the resulting curable aqueous binder composition.

In another aspect of the binder composition, a component of the composition is a copolymer emulsion of styrene and a suitable unsaturated monomer which may be stabilized with an anionic or non-ionic surfactant. Suitable monomers with an unsaturated functionality for the purposes of the present disclosure may be alkadienes. Suitable examples of alkadiene monomers include butadiene, isoprene, 1,3-pentadiene, and 2-ethyl butadiene, among others. An exemplary alkadiene monomer is butadiene.

The styrene-diene copolymer emulsion may have a viscosity of up to 2500 cPs. In some aspects, the styrene-butadiene copolymer emulsion may have a viscosity in the range of 40 cPs to 2000 cPs. In other aspects, the styrene-butadiene copolymer emulsion may have a viscosity in the range of 50 cPs to 1500 cPs.

When present, the styrene-butadiene copolymer emulsion may include solids up to 70%. In other aspects, the styrene-butadiene emulsion may have a solids content of from 35% to 65%, and in further aspects, the styrene-butadiene copolymer emulsion may have a solids content of from 40% to 60%.

The styrene-butadiene copolymer emulsion may be prepared with a styrene: butadiene ratio of about 90:10 to about 10:90. In another aspect of the disclosure, the styrene: butadiene ratio is from about 70:30 to about 30:70, and in yet further aspects, the styrene: butadiene ratio is from about 60:40 to about 40:60.

The styrene copolymer emulsion, whether incorporating an acrylate copolymer or a diene copolymer, may have a pH value that is 10.0 or less. In some aspects, the styrene copolymer emulsion may have a pH value that ranges from 3.5 to 8.5, and in other aspects, the styrene copolymer emulsion may have a pH value in the range of 4.0 to 8.0.

The concentration of the styrene copolymer emulsion in the curable aqueous binder composition may be at least 1 weight percent. In some aspects, the concentration is 2 weight percent to 50 weight percent. In other aspects, the concentration range is 5 weight percent to 40 weight percent, where the weight percent is relative to the weight of the solids content in the curable aqueous binder composition.

In some aspects of the present disclosure, the copolymer emulsion includes a carboxylated copolymer. Emulsions of carboxylated styrene-acrylate copolymers and carboxylated styrene-alkadiene copolymers are commercially available. In certain aqueous binder formulations, the presence of a carboxylated styrene copolymer may result in desirable physical properties for the resulting aqueous binder compositions, as well as conferring high mechanical strength on the engineered composite products incorporating the binders.

### Partially or Fully Hydrolyzed Polyvinyl Alcohol

The curable aqueous binder composition may include a partially and/or fully hydrolyzed polyvinyl alcohol which is commercially available as a granulated powder form. Polyvinyl alcohol is manufactured by hydrolyzing polyvinyl acetate. Polyvinyl alcohol is classified into two major categories, partially hydrolyzed and fully hydrolyzed. The amount of polyvinyl acetate in the copolymer decreases as the degree of hydrolysis increases. Also, as the degree of hydrolysis increases, the water resistance of the cured aqueous adhesive increases.

In some aspects of the present disclosure, a partially hydrolyzed polyvinyl alcohol may have a degree of hydrolysis from 84% to 94%. In other aspects, the degree of hydrolysis for partially hydrolyzed polyvinyl alcohol may range from 87% to 89%.

In some aspects of the present disclosure, a fully hydrolyzed polyvinyl alcohol may have a degree of hydrolysis from 98% to 99.8%. In other aspects, the degree of hydrolysis for fully hydrolyzed polyvinyl alcohol may range from 98% to 98.8%.

Viscosity of polyvinyl alcohol is expressed in terms of 4 wt. % solution of polyvinyl alcohol in water. A 4 wt. % solution of polyvinyl alcohol may have a viscosity of up to 100 cPs. In some aspects, a 4 wt. % solution of polyvinyl alcohol may have a viscosity from 1 cp to 90 cPS. In other aspects, a 4 wt. % solution of polyvinyl alcohol may have a viscosity in the range of 3 cPs to 80 cPs.

Weight average molecular weight of polyvinyl alcohol is a measure of polymer chain length which is being expressed in terms of 4 wt. % aqueous solution viscosity. Polyvinyl alcohol may have weight average molecular weight in the range of 10,000 to 200,000. In some aspects, polyvinyl alcohol may have weight average molecular weights from 15,000 to 190,000. In other aspects, weight average molecular weights of polyvinyl alcohol may range from 20,000 to 180,000.

The concentration of polyvinyl alcohol polymer in the resulting curable aqueous binder composition is at least 0.5%. In some aspects, the concentration of polyvinyl alcohol is from 1 wt. % to 10 wt. % in the resulting binder composition. In other aspects, the concentration of polyvinyl alcohol may range from 2 wt. % to 5 wt. % in the resulting binder composition. For each aspect, the wt. % of polyvinyl alcohol is based on the weight of the solids content in the resulting curable aqueous binder composition.

### Salts of Aldehydes

All polyvinyl alcohol grades are cross-linkable through their secondary hydroxyl functionality. Sodium bisulfite addition compounds of glyoxal and glutaraldehyde are added to the aqueous binder composition to crosslink secondary hydroxyl groups of polyvinyl alcohol. These salts remain dormant at room temperature without impacting the stability of the aqueous binder and get activated at elevated temperatures releasing aldehydes which then crosslink the secondary hydroxyl functionalities of polyvinyl alcohol increasing the crosslink density of the cured polymer network. This provides additional increase in mechanical strength and water resistance properties of engineered wood panels.

In some aspects of the present disclosure, the concentration of sodium bisulfite addition compound of aldehydes is 1 wt. % to 40 wt. %. In other aspects, the concentration of sodium bisulfite addition compound of aldehydes ranges from 2 wt. % to 20 wt. %. For each aspect, the wt. % of sodium bisulfite addition compound of aldehydes is based on the weight of polyvinyl alcohol in the aqueous binder composition.

### Ammonium Salts

Ammonium salts such as ammonium chloride, ammonium sulfate and ammonium nitrate act as crosslinkers for both partially and fully hydrolyzed polyvinyl alcohol.

In some aspects of the present disclosure, the concentration of ammonium salts may range from 1 wt. % to 20 wt. %. In other aspects, the concentration of ammonium salts may range from 2 wt. % to 10 wt. %. For each aspect, the wt. % of ammonium salts are based on the weight of polyvinyl alcohol in the aqueous binder composition.

### Aluminum salts

Aluminum salts such as aluminum chloride, aluminum sulfate and aluminum nitrate also act as strong crosslinkers for both partially and fully hydrolyzed polyvinyl alcohol.

In some aspects of the present disclosure, the concentration of aluminum salts may range from 1 wt. % to 20 wt. %. In other aspects, the concentration of aluminum salts may range from 2 wt. % to 10 wt. %. For each aspect, the wt. % of aluminum salts are based on the weight of polyvinyl alcohol in the aqueous binder composition.

### Urea

The formaldehyde-free curable aqueous binder composition may additionally contain urea. Urea may be added to a concentration of at least 2 wt. %. In some aspects, urea is added to a concentration of 5 wt. % to 90 wt. %. In other aspects, urea is added to a concentration of 10 wt. % to 80 wt. %. The wt. % of urea is based on the weight of the curable aqueous binder composition.

Without wishing to be bound by theory, it is believed that the addition of urea to the binding composition provides additional stability to the final aqueous dispersion. In addition, the presence of urea in the adhesive prepared using the binder composition may impart additional resistance to microbial attack upon engineered composite products that include the adhesive. The urea may additionally confer some flame-retardant properties on the resulting engineered composite products.

### Additional Components

The curable aqueous binder composition of the present disclosure may optionally include one or more additional components, such as for example anti-foaming agents, tackifiers, extenders, release agents, catalysts, and the like. The use of such components in curable adhesives and their workable concentrations are known in the art.

The curable aqueous binder composition may incorporate a plasticizer that is a polyol. The polyol plasticizer may be, for example, ethylene glycol, polyethylene glycol, propylene glycol, polypropylene glycol, 1,4-butane diol, glycerol, 1,2-propanediol and 1,3-propanediol, among others. When present, the polyol may be present in an amount of about 0.5% to about 40% of the solids content of the binding composition, by weight.

The curable aqueous binder composition may incorporate a defoaming agent. Any additive that is customarily used as a defoaming agent is an appropriate defoaming agent for the purposes of the present disclosure. In one aspect of the disclosure, the defoaming agent is one or more of a paraffin, a naphthalene, a polytrisiloxane, and particles of precipitated silica. When present, the defoaming agent may be present in the binding composition in an amount of about 0.1% to about 15% of the solids content, by weight.

The curable aqueous binder composition may incorporate one or more carboxylic acids. Where present, the carboxylic acid or acids may be selected from the group consisting of aliphatic monocarboxylic acids, aliphatic polycarboxylic acids, and aromatic carboxylic acids. When present, the carboxylic acid may be present in a concentration of about 0.5% to about 20% of the solids content of the binder composition, by weight.

Where the carboxylic acid is an aliphatic monocarboxylic acid, the carboxylic acid may be carbonic acid, methanoic acid, ethanoic acid, propanoic acid, butanoic acid, pentanoic acid, hexanoic acid, heptanoic acid, octanoic acid, nonanoic acid, decanoic acid, undecanoic acid, dodecanoic acid, tridecanoic acid, tetradecanoic acid, pentadecanoic acid, hexadecenoic acid, heptadecanoic acid, octadecanoic acid, nonadecanoic acid, eicosanoic acid, or any combination thereof.

Where the carboxylic acid is an aliphatic polycarboxylic acid, the carboxylic acid may be tartaric acid, maleic acid, fumaric acid, malonic acid, succinic acid, malic acid, citric acid, oxalic acid, stearic acid, or any combination thereof.

Where the carboxylic acid is an aromatic carboxylic acid, the carboxylic acid may be benzoic acid, salicylic acid, phenyl alkanoic acid, phthalic acid, isophthalic acid, terephthalic acid, or any combination thereof.

The curable aqueous binder composition may incorporate an alkali metal carboxylate. When present, the alkali metal carboxylate may be an alkali metal formate, alkali metal acetate, alkali metal lactate, alkali metal oxalate, or alkali metal citrate, or any combination thereof. The alkali metal carboxylate may be present in an amount of about 0.5% to about 20% of the solids content of the binding composition, by weight.

The curable aqueous binder composition may incorporate an alkali metal hydroxide. When present, the alkali metal hydroxide may be lithium hydroxide, sodium hydroxide, potassium hydroxide, rubidium hydroxide, cesium hydroxide, or any combination thereof. When present, the alkali metal hydroxide may be present in an amount of about 0.1% to about 30% of the solids content of the binding composition, by weight.

The curable aqueous binder composition may incorporate a release agent. When present, the release agent may be present in an amount of about 0.1% to about 20% of the solids content of the binding composition, by weight.

### Crosslinking Agent

The curable formaldehyde-free aqueous binder compositions have utility for the preparation of adhesives, and in particular for the preparation of adhesives suitable for manufacturing engineered composite products. The binder composition is made as an adhesive by the addition of an appropriate crosslinking agent in an amount sufficient to cure the resulting adhesive. The curing of the adhesive may be accelerated and/or enhanced by heating and/or applying pressure. For example, in the preparation of engineered composite wood products, heat and pressure may be applied to the resinated mat resulting after a wood furnish or fiber has been treated with a mixture of adhesive and crosslinking agent.

An appropriate crosslinking agent for the purposes of this disclosure is a crosslinking agent that includes one or more polyfunctional aromatic isocyanates. Exemplary isocyanate compounds suitable for use as crosslinking agents include 2,2′-diphenylmethane diisocyanate (2,2′-MDI), 2,4′-diphenylmethane diisocyanate (2,4′-MDI), 4,4′-diphenylmethane diisocyanate (4,4′-MDI), polymeric methylene diphenyl diisocyanate (pMDI), 2,4- and 2,6-toluene diisocyanate (TDI), naphthalene diisocyanate (NDI), isophorone diisocyanate (IPDI), hexamethylene diisocyanate (HDI), and any combination thereof.

In another aspect of the disclosure, the crosslinking agent includes two or more isocyanate groups and may be a 2,2′-MDI, 2,4′-MDI, 4,4′-MDI or pMDI. Preferably, the crosslinking agent includes one or more polymeric methylene diphenyl diisocyanates (pMDI). Many suitable isocyanate compounds are available commercially, such as for example RUBINATE (Huntsman Corp.), MONDUR (Bayer Corp.), PAPI (Dow Chemical Co.), LUPRANATE (BASF), among others. Of particular utility is the crosslinking agent sold under the tradename RUBINATE M by Huntsman Corp.

The crosslinking agent may be used to prepare an adhesive where the crosslinking agent is added to the binder composition in an amount sufficient to make up about 3% to about 70% by weight of the resulting combined adhesive. In another aspect of the disclosure, the crosslinking agent may be added in an amount sufficient to make up about 3% to about 50% by weight of the resulting combined adhesive.

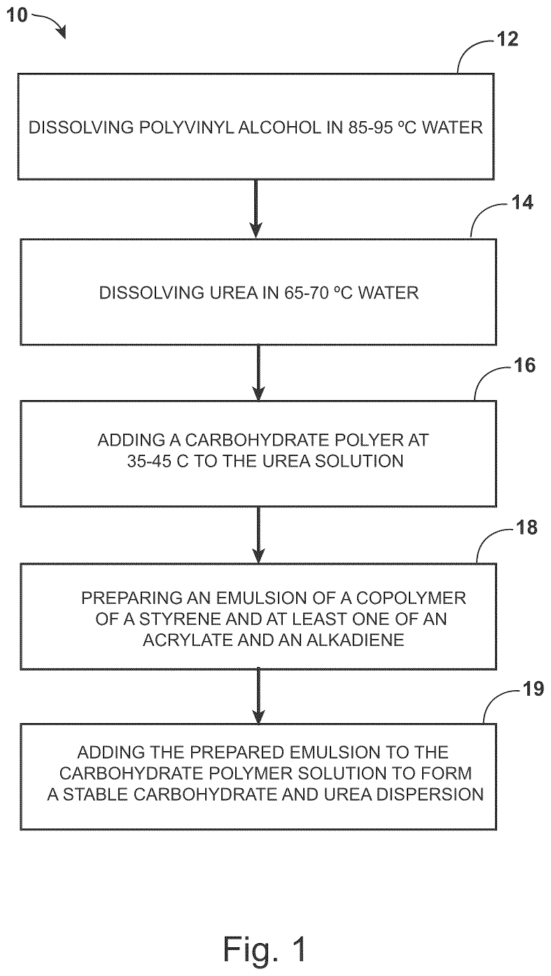

The disclosed compositions may be obtained via a method of making a curable formaldehyde-free aqueous binder, as set out in flowchart 10 of FIG. 1. The method includes the steps of fully dissolving polyvinyl alcohol powder in water at 85-95° C. at step 12, cooling the water temperature down to 65-70° C., adding urea at 65-70° C. until it is fully dissolved and then lowering the water temperature to 35-40° C. at step 14; adding a carbohydrate polymer at 35-40° C. at step 16; and adding an emulsion of a copolymer of a styrene and at least one of an acrylate and an alkadiene to the polyvinyl alcohol at step 18, urea and carbohydrate polymer solution to form a stable carbohydrate, polyvinyl alcohol and urea dispersion at step 19.

### Use of the Formaldehyde-Free Adhesive

The curable and formaldehyde-free aqueous binder compositions of the present disclosure can be used to create adhesives suitable for binding a wide variety of materials. In particular, the resulting adhesive may be used in conjunction with a variety of fibrous materials, such as for example glass fiber, glass wool, mineral wool, and others, in any combination thereof.

The aqueous binder compositions however have particular utility when used to prepare adhesives for lignocellulosic substrates. Lignocellulose refers to the material that makes up the dry matter of plants. Lignocellulose is composed of carbohydrate polymers (e.g., cellulose, hemicellulose), and an aromatic polymer (e.g., lignin), and provides a variety of plant based raw materials for industry. Lignocellulosic substrates can be derived from, for example, wood, flax, hemp, jute, bagasse, sisal, and kenaf, among others.

Where lignocellulosic substrates are used to prepare engineered composite products, the substrates can be in the form of, for example, wood particles, wood dust, wood chips, wood fibers, wood flakes, wood strands and any combination thereof. The curable aqueous binder compositions of the present disclosure, once combined with a crosslinking agent, can be sprayed onto lignocellulosic materials in the course of preparing engineered composite products such as particleboard, medium-density fiberboard, high-density fiberboard, oriented strand board (OSB), waferboard, and flake board, among others.

The aqueous binding composition can be mixed with the crosslinking agent to form the desired adhesive, which may then be sprayed onto a lignocellulosic substrate of choice. The adhesive may be used to bind particulate or stranded materials into a sheet or be applied between sheets of substrate to form a laminate material.

Once the thoroughly mixed adhesive mixture is applied to the lignocellulosic material, the combination may be heated to enhance curing. The combined materials may be heated to at least 70° C. to enhance curing. In some respects, the product may be heated to between 100° C. and 250° C. In another aspect, the product may be heated to at least 100° C., and in alternative aspect, the product may be heated to about 250° C.

The combined material is optionally pressed during curing, with the pressure applied being largely dependent upon the type of engineered product being manufactured. The combined adhesive and lignocellulosic materials may be compressed at a pressure of from 200-1,000 psi. The combined adhesive and lignocellulosic materials may be compressed at a temperature of from 100-250° C. The combined adhesive and lignocellulose materials may be compressed for 2-10 minutes.

The heat-treated product may then be cooled to room temperature. After the adhesive is cured, the resulting engineered products exhibit excellent mechanical strength and water resistance properties.

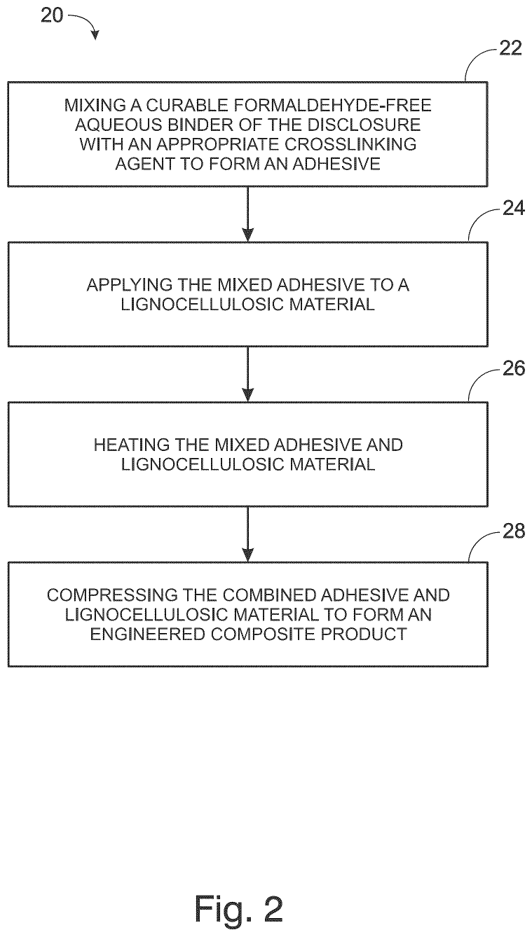

The aqueous binder compositions of the present disclosure lend themselves to a method of manufacturing an engineered composite product, as set out in flowchart 20 of FIG. 2. The method includes mixing a curable formaldehyde-free aqueous binder according to the teachings of the present disclosure with an appropriate crosslinking agent to form an adhesive, at step 22 of flowchart 20; applying the mixed adhesive to a lignocellulosic material, at step 24; heating the mixed adhesive and lignocellulosic material, at step 26; and compressing the combined adhesive and lignocellulosic material to form an engineered composite product, at step 28.

### EXAMPLES

The following examples describe selected aspects of the systems and methods of the present disclosure. These examples are intended for illustration and should not be interpreted as limiting the entire scope of the present disclosure. Each example may include one or more distinct aspects of the disclosure, and/or contextual or related information, function, and/or structure.

### Example 1: Preparation of Carbohydrate-Based Adhesive with Carboxylated Styrene Butadiene Copolymer Emulsion (Composition 1)

A four-liter reaction kettle equipped with a mechanical stirrer, thermostat and heating/cooling capability, is charged with 885 gr of water. The mixture is heated from 65° C. to 70° C. with stirring. Once the kettle temperature reaches 65-70° C., 300 gr of urea prills (Univar) are slowly added over 15-20 minutes. The mixture is stirred until all the urea is dissolved. Once the urea dissolves, the kettle temperature reaches 35-40° C. This temperature is maintained while the remaining raw materials are added.

Defoaming agent (15 gr, D-Foam-R C330 from Clariant) and carbohydrate polymer (1,350 gr, from Ingredion with D.E=9-13) are slowly added over 30 minutes, and mixing is continued until the solution is uniform. A carboxylated styrene-butadiene copolymer emulsion (300 g, ROVENE 4201, from Mallard Creek Polymers) is added and the mixture is stirred for 15 minutes. Glycerol (150 gr, 99.8% purity from Univar) is added and the mixture is stirred for an additional hour or until a homogeneous mixture is obtained at 35-40° C. The mixture is cooled to 25° C. and transferred to a 1-gallon NALGENE container for storage.

The resulting binder has the composition described in Table 1 below:

TABLE 1
Composition 1

| | Parts by Weight |
|---|---|
| Raw Materials | (pbw) |
| Water | 29.50 |
| Urea | 10.00 |
| Defoamer | 0.50 |
| Carbohydrate Polymer (D.E. = 9-13) | 45.00 |
| Carboxylated Styrene-Butadiene Copolymer | 10.00 |
| Emulsion (solids 45-55%) | |
| Glycerol | 5.00 |
| Total | 100.0 |

The resulting composition 1 has a Brookfield viscosity of 345 cPs as measured using a Brookfield viscometer at 25° C. (spindle #2, 50 rpm), a pH of 8.1, and a solids content of 65%. The resulting composition is stable at room temperature for at least 6 months.

### Example 2: Preparation of Composition 2

Composition 2 is prepared analogously to composition 1 (Example 1), excepting that citric acid is added after the addition of the defoamer and before carbohydrate addition, and sodium hydroxide (50%) is added after glycerol addition. The carboxylated styrene-butadiene copolymer emulsion of composition 1 is substituted by a styrene-acrylate copolymer dispersion. The resulting composition is described in Table 2 below:

TABLE 2
Composition 2

| | Parts by Weight |
|---|---|
| Raw Materials | (pbw) |
| Water | 23.80 |
| Urea | 26.00 |
| Defoamer | 0.80 |
| Citric Acid | 2.00 |
| Carbohydrate Polymer (D.E. = 3-8) | 30.00 |
| Styrene-Acrylate copolymer dispersion | 10.00 |
| (solids 45-55%) | |
| Glycerol | 5.00 |
| Sodium hydroxide (50%) | 2.40 |
| Total | 100.00 |

Composition 2 has a pH of 6.9, a Brookfield viscosity of 364 cPs (spindle #2, 50 rpm, 25° C.), and a solids content of 70%. The composition is stable at room temperature for 3 months.

### Example 3: Preparation of Composition 3

Composition 3 is prepared analogously to composition 2 (Example 2), excepting that the amount of citric acid is increased to 3% and the amount of sodium hydroxide (50%) is increased to 3.6%. Composition 3 has a pH of 6.7 and a solids content of 70% and is stable at room temperatures for 6 months.

### Example 4: Preparation of Composition 4

Composition 4 is prepared analogously to composition 2 (Example 2), excepting that 2% malic acid is used instead of 2% citric acid. Composition 4 has a pH of 6.8, a Brookfield viscosity of 433 cPs (spindle #2, 50 rpm, 25° C.) and a solids content of 70%.

### Example 5: Preparation of Composition 5

Composition 5 is prepared analogously to composition 2 (Example 2), excepting that the carbohydrate polymer used has a higher D.E (D.E.=9-13). Composition 5 has a pH of 7.3 and a solids content of 70%.

### Example 6: Preparation of Composition 6

Composition 6 is prepared analogously to composition 2 (Example 2), excepting that a styrene-butadiene copolymer emulsion is used in place of the styrene-acrylate copolymer dispersion. The resulting composition is provided in Table 3.

TABLE 3
Composition 6

| | Parts by Weight |
|---|---|
| Raw Materials | (pbw) |
| Water | 26.30 |
| Urea | 29.10 |
| Defoamer | 0.20 |
| Citric Acid | 2.00 |
| Carbohydrate Polymer (D.E. = 3-8) | 30.00 |
| Styrene-Butadiene Emulsion | 5.00 |
| (solids 45-55%) | |
| Glycerol | 5.00 |
| Sodium hydroxide (50%) | 2.40 |
| Total | 100.00 |

Composition 6 has a pH of 7.1, a Brookfield viscosity of 166 cPs (spindle #2, 50 rpm, 25° C.) and a solids content of 70% and is stable at room temperatures for 6 months.

### Example 7: Preparation of Composition 7

Composition 7 is prepared analogously to composition 6 (Example 6), excepting that the amount of citric acid is increased to 3% and the amount of sodium hydroxide (50%) is raised to 3.2%. Composition 7 has a pH of 6.2, a Brookfield viscosity of 146 cPs (spindle #2, 50 rpm, 25° C.) and a solids content of 70%.

### Example 8: Preparation of Composition 8

Composition 8 is prepared analogously to composition 2 (Example 2), excepting that the amount of styrene-acrylate copolymer dispersion is reduced to 7% and 1% of a release agent is added to the composition. Composition 8 has a pH of 6.3, a Brookfield viscosity of 230 cPs (spindle #2, 50 rpm, 25° C.) and a solids content of 70% and is stable at room temperatures for 4 months.

### Example 9: Preparation of Composition 9

Composition 9 is prepared analogously to composition 2 (Example 2), excepting that the amount of styrene-acrylate copolymer dispersion is reduced to 5% and 5% of a release agent is added to the composition. Composition 9 has a pH of 6.0, a Brookfield viscosity of 350 cPs (spindle #2, 50 rpm, 25° C.) and a solids content of 70% and is stable at room temperatures for 2 months.

### Example 10: Preparation of Composition 10

Composition 10 is prepared analogously to composition 9 (Example 9), excepting that the amounts of citric acid and sodium hydroxide (50%) are each reduced to 1%. Composition 10 has a pH of 5.7, a Brookfield viscosity of 300 cPs (spindle #2, 50 rpm, 25° C.) and a solids content of 70% and is stable at room temperatures for 2 months.

### Example 11: Preparation of Composition 11

Composition 11 is prepared analogously to composition 10 (Example 10), excepting that 1.4% potassium hydroxide (45%) is used in place of 1% sodium hydroxide (50%). Composition 10 has a pH of 6.2, a Brookfield viscosity of 165 cPs (spindle #2, 50 rpm, 25° C.) and a solids content of 70% and is stable at room temperatures for 3 months.

### Example 12: Preparation of Composition 12

Composition 12 is prepared analogously to composition 3 (Example 3), excepting that 3% sodium citrate is used instead of citric acid and sodium hydroxide, and the amount of styrene-acrylate copolymer dispersion is reduced to 5%. Composition 12 has a pH of 7.8, a Brookfield viscosity of 215 cPs (spindle #2, 50 rpm, 25° C.), and a solids content of 70%, and is stable at room temperatures for 3 months.

### Example 13: Preparation of Composition 13

Composition 13 is prepared analogously to composition 6 (Example 6), excepting that no citric acid or sodium hydroxide is used, and 1% release agent and 0.5% sodium bicarbonate are added. The resulting composition is described in Table 4.

TABLE 4
Composition 13

| | Parts by Weight |
|---|---|
| Raw Materials | (pbw) |
| Water | 26.50 |
| Urea | 31.80 |
| Defoamer | 0.20 |
| Sodium Bicarbonate | 0.50 |
| Carbohydrate Polymer (D.E. = 3-8) | 30.00 |
| Styrene-Butadiene Emulsion | 5.00 |
| (solids 45-55%) | |
| Glycerol | 5.00 |
| Release Agent | 1.00 |
| Total | 100.00 |

Composition 13 has a pH of 9.2, a Brookfield viscosity of 285 cPs (spindle #2, 50 rpm, 25° C.), and a solids content of 70%, and is stable at room temperatures for 3 months.

### Example 14: Preparation of Composition 14

Composition 14 is prepared analogously to composition 13 (Example 13), excepting that the amount of sodium bicarbonate is increased to 1%, and the amount of release agent is increased to 1.2%. Composition 14 has a pH of 9.1, a Brookfield viscosity of 410 cPs (spindle #2, 50 rpm, 25° C.), and a solids content of 70%, and is stable at room temperatures for 2 months.

### Example 15: Preparation of Composition 15

Composition 15 is prepared analogously to composition 14 (Example 14), excepting that the amount of sodium bicarbonate is increased to 2%. Composition 15 has a pH of 8.9 and a solids content of 70%.

### Example 16: Preparation of Composition 16

Composition 16 is prepared analogously to composition 1 (Example 1), excepting that the amount of styrene-butadiene copolymer emulsion is increased to 20 parts by weight, the amount of water is reduced to 24.5 parts by weight, and the amount of carbohydrate polymer is reduced to 40 parts by weight. Composition 16 has a pH of 8.1, a Brookfield viscosity of 280 cPs (spindle #2, 50 rpm, 25° C.), and a solids content of 65%, and is stable for at least 6 months at room temperature.

### Example 17: Preparation of Composition 17

Composition 17 is prepared analogously to composition 16 (Example 16), excepting that a carbohydrate polymer having a lower D.E. is used (D.E.=3-8). Composition 17 has a pH of 7.6, a Brookfield viscosity=725 cPs (spindle #3, 30 rpm, 25° C.), and a solids content of 65%, and is stable for at least 6 months at room temperature.

### Example 18: Preparation of Composition 18

Composition 18 is prepared analogously to composition 17 (Example 17), excepting that the amount of carbohydrate polymer is reduced to 30 parts by weight, and the amount of urea is increased to 20 parts by weight. Composition 18 has a pH of 7.9, a Brookfield viscosity of 194 cPs (spindle #2, 50 rpm, 25° C.), a solids content of 65%, and is stable at room temperature for at least 6 months.

Example 19: Preparation of Composition 19

Composition 19 is prepared analogously to composition 18 (Example 18), excepting that the amount of urea is reduced to 15 parts by weight, and the amount of glycerol is increased to 10 parts by weight. Composition 19 has a pH of 7.9, a Brookfield viscosity of 244 cPs (spindle #2, 50 rpm, 25° C.), a solids content of 65%, and is stable at room temperature for at least 6 months.

### Example 20: Preparation of Composition 20

Composition 20 is prepared analogously to composition 1 (Example 1), excepting the ingredients are as listed below in Table 5.

TABLE 5
Composition 20

| | Parts by Weight |
|---|---|
| Raw Materials | (pbw) |
| Water | 29.50 |
| Urea | 5.00 |
| Defoamer | 0.50 |
| Carbohydrate Polymer (D.E. = 16-20) | 50.00 |
| Styrene-Acrylate copolymer dispersion | 10.00 |
| (solids 45-55%) | |
| Glycerol | 5.00 |
| Total | 100.00 |

Composition 20 has a pH of 7.0, a Brookfield viscosity of 280 cPs (spindle #2, 50 rpm, 25° C.), a solids content of 65%, and is stable at room temperature for at least 6 months.

### Example 21: Preparation of Composition 21

Composition 21 is prepared analogously to composition 20 (Example 20), excepting that no urea is used, and the amount of styrene-acrylate copolymer dispersion is increased to 20 parts by weight. Composition 21 has a pH of 6.7, a solids content of 65%, a Brookfield viscosity of 415 cPs (spindle #2, 50 rpm, 25° C.), and is stable at room temperature for at least 6 months.

### Example 22: Preparation of Composition 22

Composition 22 is prepared analogously to composition 20 (Example 20), excepting that a carbohydrate polymer having a lower D.E. (D.E.=9-13) is used, the amount of carbohydrate is reduced to 40 parts by weight, and the amount of urea is increased to 15 parts by weight. Composition 22 has a pH of 7.0, a Brookfield viscosity of 180 cPs (spindle #2, 50 rpm, 25° C.), a solids content of 65%, and is stable at room temperature for at least 6 months.

### Example 23: Preparation of Composition 23

Composition 23 is prepared analogously to composition 20 (Example 20), excepting that a carbohydrate polymer having a lower D.E. (D.E.=3-8) is used, the amount of carbohydrate is reduced to 30 parts by weight, the amount of urea is increased to 20 parts by weight, and the amount of styrene-acrylate copolymer dispersion is increased to 20 parts by weight. Composition 23 has a pH of 6.5, a Brookfield viscosity of 184 cPs (spindle #2, 50 rpm, 25° C.), a solids content of 65%, and is stable at room temperature for at least 6 months.

### Example 24: Preparation of Composition 24

Composition 24 is prepared analogously to composition 23 (Example 23), excepting that the amount of urea is increased to 30 parts by weight, and the amount of styrene-acrylate copolymer dispersion is reduced to 10 parts by weight. Composition 24 has a pH of 6.8, a Brookfield viscosity of 186 cPs (spindle #2, 50 rpm, 25° C.), a solids content of 70%, and is stable at room temperature for at least 6 months.

### Example 25: Preparation of Composition 25

Composition 25 is prepared analogously to composition 23 (Example 23), excepting that the amount of urea is increased to 32 parts by weight, and the amount of styrene-acrylate copolymer dispersion is reduced to 5 parts by weight. Composition 25 has a pH of 6.5, a Brookfield viscosity of 163 cPs (spindle #2, 50 rpm, 25° C.), a solids content of 70%, and is stable at room temperature for at least 6 months.

### Example 26: Preparation of Composition 26

Composition 26 is prepared analogously to composition 22 (Example 22), excepting that the amount of urea is increased to 20 parts by weight. Composition 26 has a pH of 7.3, a Brookfield viscosity of 249 cPs (spindle #2, 50 rpm, 25° C.), a solids content of 70%, and is stable at room temperature for at least 6 months.

### Example 27: Preparation of Composition 27

Composition 27 is prepared analogously to composition 22 (Example 22), excepting that the amount of carbohydrate polymer is reduced to 35 parts by weight, the amount of urea is increased to 27.2 parts by weight, and the amount of styrene-acrylate copolymer dispersion is reduced to 5 parts by weight. Composition 27 has a pH of 7.8, a Brookfield viscosity of 105 cPs (spindle #2, 50 rpm, 25° C.), a solids content of 70%, and is stable at room temperature for at least 6 months.

### Example 28: Preparation of Composition 28

Composition 28 is prepared analogously to composition 23 (Example 23), excepting that the amount of carbohydrate polymer is increased to 35 parts by weight, the amount of urea is increased to 27.5 parts by weight, and the amount of styrene-acrylate copolymer dispersion is reduced to 5 parts by weight. Composition 28 has a pH of 6.7, a Brookfield viscosity of 343 cPs (spindle #2, 50 rpm, 25° C.), a solids content of 70%, and is stable at room temperature for at least 6 months.

### Example 29: Preparation of Composition 29

Composition 29 is prepared analogously to composition 28 (Example 28), excepting that the amount of urea is reduced to 15 parts by weight, the amount of styrene acrylate copolymer dispersion is increased to 10 parts by weight, and the amount of glycerol is increased to 10 parts by weight. Composition 29 has a pH of 5.9, a Brookfield viscosity of 367 cPs (spindle #2, 50 rpm, 25° C.), a solids content of 65%, and is stable at room temperature for at least 1 month.

### Example 30: Preparation of Composition 30

Composition 30 is prepared analogously to composition 29 (Example 29), excepting that the amount of styrene-acrylate copolymer dispersion is increased to 20 parts by weight and the amount of glycerol is reduced to 5 parts by weight. Composition 30 has a pH of 6.4, a Brookfield viscosity of 472 cPs (spindle #2, 50 rpm, 25° C.), a solids content of 65%, and is stable at room temperature for 3 weeks.

### Example 31: Preparation of Composition 31

Composition 31 is prepared analogously to composition 23 (Example 23), excepting that the amount of carbohydrate polymer is increased to 40 parts by weight and the amount of urea is reduced to 10 parts by weight. Composition 31 has a pH of 6.2, a Brookfield viscosity of 505 cPs (spindle #3, 30 rpm, 25° C.), a solids content of 65%, and is stable at room temperature for 3 weeks.

### Example 32: Preparation of Composition 32

Composition 32 is prepared analogously to composition 1 (Example 1), using the ingredients set out in Table 6 below. The styrene-acrylate copolymer dispersion used in the preparation differs from the dispersion used in Example 20 in that it is self-crosslinking with lower active solids and a lower pH.

TABLE 6
Composition 32

| | Parts by Weight |
|---|---|
| Raw Materials | (pbw) |
| Water | 23.50 |
| Urea | 25.00 |
| Defoamer | 0.40 |
| Carbohydrate Polymer (D.E. = 3-8) | 35.00 |
| Styrene-Acrylate copolymer dispersion | 11.10 |
| (solids 40-50%) | |
| Glycerol | 5.00 |
| Total | 100.00 |

Composition 32 has a pH of 6.2, a Brookfield viscosity of 395 cPs (spindle #2, 50 rpm, 25° C.), a solids content of 70%, and is stable at room temperature for 3 weeks.

### Example 33: Preparation of Composition 33

Composition 33 is prepared analogously to composition 32 (Example 32), excepting that the amount of carbohydrate polymer is reduced to 30 parts by weight, and the amount of urea is increased to 30 parts by weight. Composition 33 has a pH of 6.5, a Brookfield viscosity of 172 cPs (spindle #2, 50 rpm, 25° C.), a solids content of 70%, and is stable at room temperature for at least 2 months.

### Example 34: Preparation of Composition 34

Composition 34 is prepared analogously to composition 33 (Example 33), excepting that the amount of urea is increased to 32.3 parts by weight, and the amount of styrene-acrylate copolymer dispersion is reduced to 5.6 parts by weight. Composition 34 has a pH of 6.5, a Brookfield viscosity of 144 cPs (spindle #2, 50 rpm, 25° C.), a solids content of 70%, and is stable at room temperature for at least 2 months.

### Example 35: Preparation of Composition 35

Composition 35 is prepared analogously to composition 32 (Example 32), excepting that the amount of carbohydrate polymer is reduced to 30 parts by weight, the amount of urea is reduced to 20 parts by weight, and the amount of the styrene-acrylate copolymer dispersion is increased to 22.2 parts by weight. Composition 35 has a pH of 5.3, a Brookfield viscosity of 184 cPs (spindle #2, 50 rpm, 25° C.), a solids content of 65%, and is stable at room temperature for at least 4 months.

### Example 36: Preparation of Composition 36

Composition 36 is prepared analogously to composition 1 (Example 1), excepting with the ingredients set out in Table 7 below:

TABLE 7
Composition 36

| | Parts by Weight |
|---|---|
| Raw Materials | (pbw) |
| Water | 27.50 |
| Urea | 31.70 |
| Defoamer | 0.30 |
| Carbohydrate Polymer (D.E. = 3-8) | 30.00 |
| Styrene-Acrylate copolymer dispersion | 5.00 |
| (solids 45-55%) | |
| Glycerol | 5.00 |
| Release Agent | 0.50 |
| Total | 100.00 |

Composition 36 has a pH of 6.8, a Brookfield viscosity of 158 cPs (spindle #2, 50 rpm, 25° C.), a solids content of 70%, and is stable at room temperature for at least 6 months.

### Example 37: Preparation of Composition 37

Composition 37 is prepared analogously to composition 36 (Example 36), excepting the amount of release agent is increased to 1.0 part by weight and the amount of urea is reduced to 31.3 parts by weight. Composition 37 has a pH of 7.4, a Brookfield viscosity of 251 cPs (spindle #2, 50 rpm, 25° C.), a solids content of 70%, and is stable at room temperature for at least 6 months.

### Example 38: Preparation of Composition 38

Composition 38 is prepared analogously to composition 36 (Example 36), excepting that the amount of release agent is increased to 1.5 part by weight and the amount of urea is reduced to 30.8 parts by weight. Composition 38 has a pH of 7.5, a Brookfield viscosity of 900 cPs (spindle #2, 30 rpm, 25° C.), a solids content of 70%, and is stable at room temperature for at least 2 months.

### Example 39: Preparation of Composition 39

Composition 39 is prepared analogously to composition 36 (Example 36), excepting that a different styrene-acrylate copolymer dispersion (having a solids content of 40-50%) is used. Composition 39 has a pH of 7.3, a Brookfield viscosity of 169 cPs (spindle #2, 50 rpm, 25° C.), a solids content of 70%, and is stable at room temperature for at least 2 months.

### Example 40: Preparation of Composition 40

Composition 40 is prepared analogously to composition 36 (Example 36), excepting that PREVENTOL™ insecticide is used in place of the release agent. Composition 40 has a pH of 6.9, a Brookfield viscosity of 160 cPs (spindle #2, 50 rpm, 25° C.), a solids content of 70%, and is stable at room temperatures for 6 months.

### Example 41: Preparation of Composition 41

Composition 41 is prepared analogously to composition 1 (Example 1), excepting that the ingredients set out in Table 8 are used.

TABLE 8
Composition 41

| | Parts by Weight |
|---|---|
| Raw Materials | (pbw) |
| Water | 34.50 |
| Urea | 10.00 |
| Defoamer | 0.50 |
| Carbohydrate Polymer (D.E. = 16-20) | 50.00 |
| Glycerol | 5.00 |
| Total | 100.00 |

Composition 41 has a pH of 7.8, a Brookfield viscosity of 163 cPs (spindle #2, 50 rpm, 25° C.), a solids content of 65%, and is stable at room temperature for at least 6 months.

### Example 42: Preparation of Composition 42

Composition 42 is prepared analogously to composition 41 (Example 41), excepting that a carbohydrate polymer having a lower D. E. (D.E.=3-8) is used. The amount of carbohydrate polymer is reduced to 40 parts by weight, and the amount of urea is increased to 20 parts by weight. Composition 42 has a pH of 5.6, a Brookfield viscosity of 373 cPs (spindle #2, 50 rpm, 25° C.), a solids content of 65%, and is stable at room temperature for 2 weeks.

### Example 43: Preparation of Composition 43

Composition 43 is prepared analogously to composition 42 (Example 42), excepting that the amount of carbohydrate polymer is reduced to 35 parts by weight, and the amount of urea is increased to 25 parts by weight. Composition 43 has a pH of 5.9, a Brookfield viscosity of 183 cPs (spindle #2, 30 rpm, 25° C.), a solids content of 65%, and is stable at room temperature for at least 6 months.

### Example 44: Preparation of Carbohydrate-Based Adhesive with Partially Hydrolyzed Polyvinyl Alcohol (Composition 44)

A four-liter reaction kettle equipped with a mechanical stirrer, thermostat and heating/cooling capability, is charged with tap water (984 gr). Increase the water temperature to 40° C. to 45° C. Once the kettle temperature reaches 40-45° C., charge partially hydrolyzed polyvinyl alcohol (32 gr, Poval 217, from Kuraray America) slowly with sufficient mixing. Raise the kettle temperature to 85-90° C. when the addition of polyvinyl alcohol is complete. When the kettle temperature reaches 85-90° C., hold it at that temperature for at least 30 minutes or until all the polyvinyl alcohol has been dissolved. Lower the kettle temperature to 65-70° C. Once the kettle temperature reaches 65-70° C., urea prills (1192 gr, from Univar) are slowly added over 15-20 minutes. The mixture is stirred until all the urea is dissolved. Once the urea fully dissolves, the kettle temperature reaches 35-40° C. This temperature is maintained while the remaining raw materials are added.

Defoaming agent (16 gr, D-Foam-R C330 from Clariant) and carbohydrate polymer (1,200 gr, from Ingredion with D.E=9-13) are slowly added over 30 minutes, and mixing is continued until the solution is uniform. A carboxylated styrene-acrylate copolymer emulsion (400 g, ROVENE 6065, from Mallard Creek Polymers) is added and the mixture is stirred for 15 minutes. Add glutaraldehyde sodium bisulfite addition compound (8 gr, from Sigma-Aldrich) and mix for 15-20 minutes. Glycerol (168 gr, from Univar) is added and the mixture is stirred for an additional hour or until a homogeneous mixture is obtained at 35-40° C. The mixture is cooled to 25° C. and transferred to a 1-gallon NALGENE container for storage.

The resulting binder has the composition described in Table 9 below:

TABLE 9
Composition 44

| | Parts by Weight |
|---|---|
| Raw Materials | (pbw) |
| Water | 24.60 |
| Partially hydrolyzed polyvinyl alcohol | 0.80 |
| Urea | 29.80 |
| Defoamer | 0.40 |
| Carbohydrate Polymer (D.E. = 3-8) | 30.00 |
| Styrene-Acrylate copolymer dispersion | 10.00 |
| (solids 45-55%) | |
| Glycerol | 4.20 |
| Glutaraldehyde sodium bisulfite addition compound | 0.20 |
| Total | 100.00 |

The resulting composition 44 has a Brookfield viscosity of 300 cPs as measured using a Brookfield viscometer at 25° C. (spindle #2, 50 rpm), a pH of 6.6, and a solids content of 70%.

### Example 45: Preparation of Composition 45

Composition 45 is prepared analogously to composition 44 (Example 44), excepting that glutaraldehyde sodium bisulfite addition compound has been substituted with glyoxal sodium bisulfite addition compound. Composition 45 has a pH of 6.6, a Brookfield viscosity of 300 cPs (spindle #2, 50 rpm), and a solids content of 70%.

### Example 46: Preparation of Composition 46

Composition 46 is prepared analogously to composition 44 (Example 44), excepting that 0.2% glutaraldehyde sodium bisulfite addition compound has been substituted with 0.13% of (60%) aluminum nitrate solution and 0.07% water. Composition 46 has a pH of 6.4, a Brookfield viscosity of 300 cPs (spindle #2, 50 rpm), and a solids content of 69.9%.

### Example 47: Preparation of Composition 47

Composition 47 is prepared analogously to composition 44 (Example 44), excepting that 0.2% glutaraldehyde sodium bisulfite addition compound has been substituted with 0.2% of (40%) ammonium sulfate solution. Composition 47 has a pH of 6.5, a Brookfield viscosity of 300 cPs (spindle #2, 50 rpm), and a solids content of 69.9%.

### Example 48: Preparation of Composition 48

Composition 48 is prepared analogously to composition 44 (Example 44), excepting that 0.8% partially hydrolyzed polyvinyl alcohol has been substituted with 0.4% fully hydrolyzed polyvinyl alcohol and 0.4% partially hydrolyzed polyvinyl alcohol. Composition 48 has a pH of 6.6, a Brookfield viscosity of 267 cPs (spindle #2, 50 rpm), and a solids content of 70%.

### Example 49: Particleboard Manufacture and Testing

An appropriate amount of wood particles (e.g., Douglas fir) are weighed and loaded into a rotating blender. A binding composition according to the present disclosure is thoroughly mixed with a crosslinking agent, and the resulting adhesive is applied via air-atomization at 50 psi. The wood particles are blended for up to five minutes in the rotating blender after addition of the adhesive is complete, and then transferred to a forming box. The wood particles and adhesive mixture is formed into mats by hand using the forming box. The formed mats are then consolidated with heat and pressure using a computer-controlled hydraulic hot-press system. The mats are supported by caul plates on top and bottom while consolidated in the hot press system at a temperature of 160° C. The press schedule can be replicated with no variation between trials, three particleboards were manufactured from each blender load using the same procedure. Specifications for the resulting particleboard panels are provided in Table 10 below.

TABLE 10
Particleboard Manufacturing Specifications

| Furnish species: | Douglas-fir | |
|---|---|---|
| Target panel density (dry basis): | 45 pcf (pounds per cubic ft.) | |
| Bio-adhesive loading: | ≤7% | |
| pMDI loading | ≤2% | |
| Air atomization pressure | 50 | psi |
| Neat furnish MC: | 5% | |
| Press temperature: | 160° | C. |
| Total cycle time: | 240 | sec |

| | |
|---|---|
| Nominal panel dimensions: | 0.5 inch × 24 inch × 24 inch |

### Panel Testing:

Particleboard testing is performed following the procedures set out in ASTM D1037, and includes tests for internal bond, static bending (modulus of rupture, modulus of elasticity), and percent thickness swell. All test panels are stored at 20° C. and 65% relative humidity until equilibrium moisture content is reached (approximately 2 weeks). Specimens are cut from various positions within the panel to randomize edge and corner effects. Internal bond and static bending specimens are tested at the conditioned moisture content. Weight and dimensions are measured for each specimen. Percent thickness swell is determined as the percent change of thickness from the conditioned moisture content to a thickness after 24 hour soak in water.

### Data Analysis:

Summary statistics ae prepared for all treatments. An analysis of variance is used to identify any statistically significant differences between treatments.

### Example 50: Preparation and Testing of Single layer ½″ Douglas-Fir Particleboards Using pMDI Crosslinking Agent

A binding composition according to the present disclosure is thoroughly mixed with a pMDI crosslinking agent for up to 5 minutes in order to obtain a homogeneous mixture. The resulting mixed adhesive is pumped to a nozzle head for spraying on douglas-fir furnish. The amount of pMDI is 2% based on the weight of dry wood furnish in the control adhesive system. In the comparative examples shown in Table 11, the amount of binding composition is 7% and the amount of pMDI is 1.2% based on the weight of dry wood furnish.

At the end of the blending cycle, the rotary blender is emptied, and the first mat is formed immediately prior to pressing. Three particleboard mats are formed from each blender load. No more than 45 minutes elapse between the first and the third mat formed from the adhesive mixed particles of the same blender load.

The hand formed 24″×24″ adhesive mixed mat is placed in a hot press maintained at 160° C. and pressed for 240 sec. The finished particleboards had a target density of 45 pounds per cubic ft. (pcf) with a thickness of ½″.

The particleboards are prepared and tested analogously with pMDI (e.g., RUBINATE M from Huntsman) is used as control adhesive. The results from the mechanical property testing are presented in Table 11 below.

TABLE 11
Particleboard Mechanical Properties

| | Adhesive | Adhesive | pMDI | Internal Bond | Modulus of | Modulus of |
|---|---|---|---|---|---|---|
| Example | Example | content | content | Strength | Rupture | Elasticity |
| Number | Number | (%) | (%) | (psi) | (psi) | (psi) |
| pMDI | pMDI | 0.0 | 2.0 | 65.00 ± 10.60 | 902 ± 165.23 | 216004 ± 28952 |
| 45-A | 24 | 7.0 | 1.2 | 46.00 ± 7.90 | 875 ± 131.5 | 204927 ± 23788 |
| 45-B | 25 | 7.0 | 1.2 | 71.50 ± 14.50 | 949 ± 250.2 | 224285 ± 47579 |
| 45-C | 27 | 7.0 | 1.2 | 56.60 ± 14.90 | 958.3 ± 188.06 | 227171 ± 33721 |
| 45-D | 35 | 7.0 | 1.2 | 77.10 ± 21.70 | 1079.5 ± 179.4 | 212337 ± 78119 |

Higher values of internal bond strength, modulus of rupture and modulus of elasticity are indicative of more robust particleboards. All examples of particleboards manufactured except for adhesive Example 24 cited in Table 11 give comparatively higher mechanical strength properties than those made with pMDI.

### Example 51: Preparation and Testing of Single Layer ½″ Douglas-Fir Particleboards Using pMDI Crosslinking agent

The aqueous adhesive composition is mixed with pMDI cross-linker for up to 5 minutes to obtain a homogeneous mixture and the mixed adhesive is pumped to the nozzle head for spraying on douglas-fir furnish. The pMDI amount is 2% based on the weight of dry wood furnish in the control adhesive system. In the comparative examples set out in Table 12, the aqueous adhesive amount is varied from 2.5% to 7.0% and the pMDI amount ranged from 0.5% to 1.2% based on the weight of dry wood furnish. At the end of the blending cycle, the rotary blender is emptied, and the first mat is formed immediately prior to pressing. Three particleboard mats are formed from each blender load. No more than 45 minutes elapse between the first and the third mat formed from the adhesive mixed particles of the same blender load.

The hand formed 24″×24″ adhesive mixed mat is placed in a hot press maintained at 160° C. and pressed for 240 sec. The finished particleboards had a target density of 45 pounds per cubic ft. (pcf) with a thickness of ½″.

The particleboards are prepared and tested analogously with pMDI (e.g., RUBINATE M from Huntsman) used as control adhesive. The results from the mechanical property testing are presented in Table 12 below.

TABLE 12
Mechanical Properties of Particleboards

| | Adhesive | Adhesive | pMDI | Internal Bond | Modulus of | Modulus of |
|---|---|---|---|---|---|---|
| Example | Example | content | content | Strength | Rupture | Elasticity |
| Number | Number | (%) | (%) | (psi) | (psi) | (psi) |
| pMDI | pMDI | 0.0 | 2.0 | 61.6 ± 15.8 | 888 ± 202 | 208067 ± 37713 |
| 46-A1 | 39 | 2.5 | 0.5 | 22.2 ± 7.7 | 587 ± 178 | 144567 ± 43907 |
| 46-A2 | 39 | 3.5 | 0.5 | 24.3 ± 8.7 | 606 ± 105 | 153200 ± 23997 |
| 46-A3 | 39 | 4.0 | 1.0 | 57.2 ± 10.5 | 905 ± 143 | 209933 ± 31210 |
| 46-B1 | 34 | 7.0 | 0.40 | 20.3 ± 5.2 | 630 ± 138 | 154600 ± 23007 |
| 46-B2 | 34 | 7.0 | 0.80 | 44.9 ± 12.9 | 872 ± 165 | 205800 ± 27560 |
| 46-B3 | 34 | 7.0 | 1.20 | 58.4 ± 17.2 | 1031 ± 196 | 246400 ± 42693 |
| 46-C1 | 25 | 7.0 | 1.20 | 72.5 ± 28.7 | 1253 ± 190 | 260900 ± 42383 |
| 46-C2 | 25 | 7.0 | 0.80 | 50.10 ± 16.3 | 874 ± 121 | 215300 ± 32187 |
| 46-C3 | 25 | 7.0 | 0.40 | 20.4 ± 6.4 | 608 ± 72 | 165200 ± 17057 |

As shown in Table 12, particleboards manufactured with lower amount of adhesive combined with lower amount of pMDI demonstrate poor mechanical strength properties. For a fixed amount of adhesive in the adhesive/pMDI mixture, as the pMDI amount is increased from 0.8% to 1.2%, a marked increase in mechanical strength properties is observed.

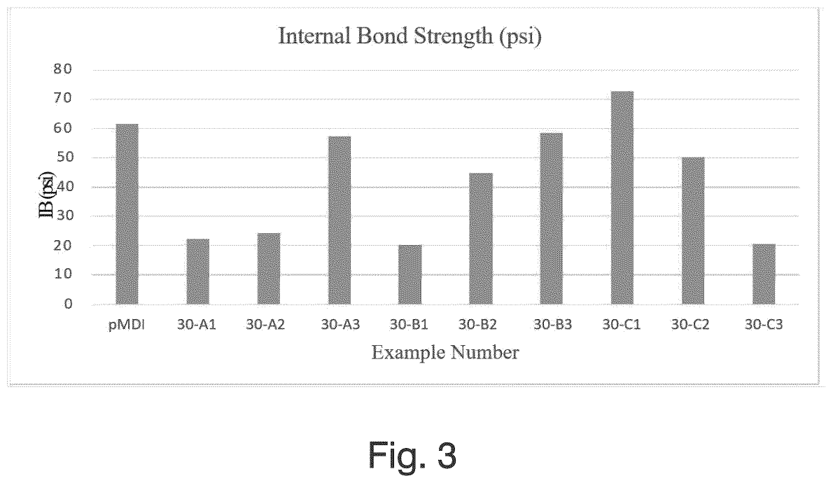

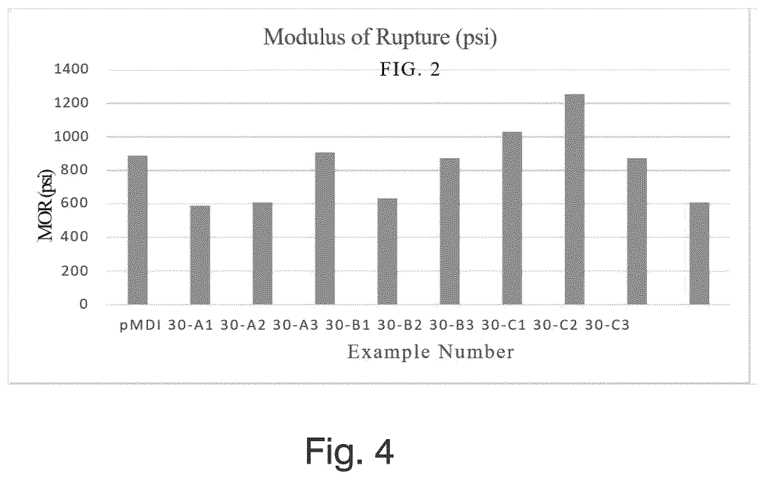

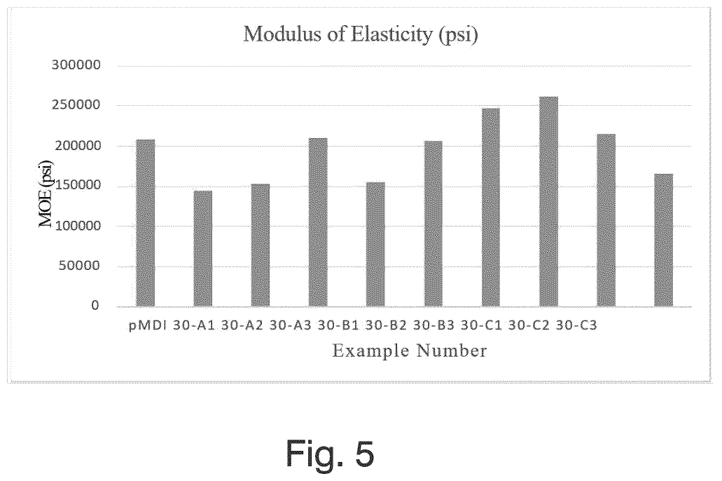

As shown in FIGS. 3-5 (corresponding to example nos. 46-A1 to 46-A3 in Table 12), as the adhesive content is increased from 2.5% to 4.0% and pMDI content is increased from 0.5% to 1.0%, a marked increase in internal bond strength, modulus of rupture and modulus of elasticity is observed.

As shown in FIGS. 3-5 (example nos. 46-B1 to 46-B3, Table 12), as pMDI content is increased from 0.4% to 1.2% at a fixed adhesive content of 7.0%, an increasing trend in internal bond strength, modulus of rupture and modulus of elasticity is observed.

As shown in FIGS. 3-5 (example nos. 46-C1 to 46-C3, Table 12), as pMDI content is reduced from 1.2% to 0.4% at a fixed adhesive content of 7.0%, a decreasing trend in internal bond strength, modulus of rupture and modulus of elasticity is observed. In addition, particleboards manufactured using example numbers 46-B3 and 46-C1 (Table 12, FIGS. 3-5) showed higher mechanical strength properties than those manufactured using 2% pMDI and 0% adhesive.

The moisture resistance properties of particleboard panels manufactured with examples from Table 12, in terms of percent thickness swell, are presented in Table 13 below.

TABLE 13
Moisture Resistance Properties of Particleboards

| | Adhesive | | | |
|---|---|---|---|---|
| Example | Example | Adhesive | pMDI | % Thickness |
| Number | Number | content (%) | content (%) | Swell |
| pMDI | pMDI | 0.0 | 2.0 | 39.9 ± 1.98 |
| 46-A1 | 39 | 2.5 | 0.5 | 87.4 ± 4.56 |
| 46-A2 | 39 | 3.5 | 0.5 | 87.7 ± 2.72 |
| 46-A3 | 39 | 4.0 | 1.0 | 56.7 ± 1.86 |
| 46-B1 | 34 | 7.0 | 0.40 | 90.5 ± 4.18 |
| 46-B2 | 34 | 7.0 | 0.80 | 71.4 ± 2.25 |
| 46-B3 | 34 | 7.0 | 1.20 | 62.4 ± 1.88 |
| 46-C1 | 25 | 7.0 | 1.20 | 45.7 ± 0.72 |
| 46-C2 | 25 | 7.0 | 0.80 | 70.6 ± 4.81 |
| 46-C3 | 25 | 7.0 | 0.40 | 113.0 ± 7.03 |

Lower values of percent thickness swell are indicative of higher moisture resistance properties. As shown in Table 13, with the amount of adhesive fixed, as the pMDI content is increased from 0.4% to 1.2% based on the weight of oven dry wood furnish, the moisture resistance properties of the particleboards continually improve.

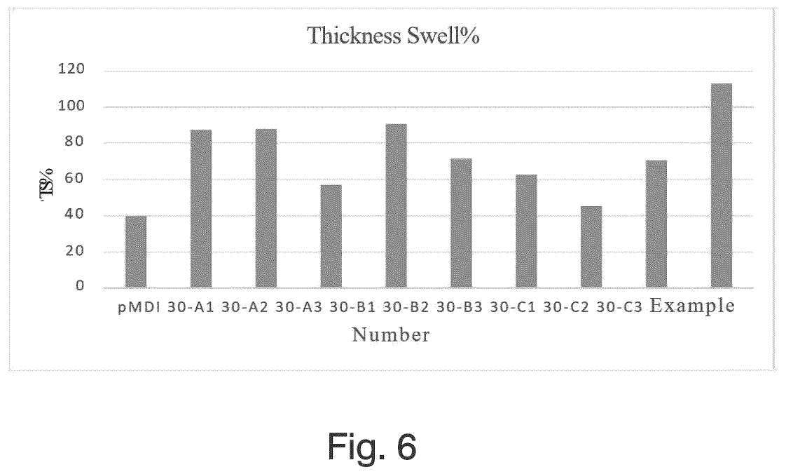

As shown in FIG. 6 (example nos. 46-A1 to 46-A3, Table 13), as the adhesive content increases from 2.5% to 4.0% and pMDI content increases from 0.5% to 1.0%, percent thickness swell values decreased.

As shown in FIG. 6 (example nos. 46-B1 to 46-B3, Table 13), as pMDI content increases from 0.4% to 1.2% at a fixed adhesive content of 7.0%, percent thickness swell values continually decrease.

In addition, also as shown in FIG.6 (example nos. 46-C1 to 46-C3, Table 13), as pMDI content is reduced from 1.2% to 0.4% for a fixed adhesive content of 7.0%, the percent thickness swell values increase. In addition, particleboards manufactured using example number 46-C1 showed similar percent thickness values compared to particleboards manufactured using 2.0% pMDI.

### Example 52: Exemplary Embodiments

This section describes additional aspects and features of the systems and methods of the present disclosure, presented without limitation as a series of paragraphs, some or all of which may be alphanumerically designated for clarity and efficiency. Each of these paragraphs can be combined with one or more other paragraphs, and/or with disclosure from elsewhere in this application, in any suitable manner. Some of the paragraphs below expressly refer to and further limit other paragraphs, providing without limitation examples of some of the suitable combinations.

A1. A formaldehyde-free curable aqueous composition for bonding lignocellulosic material comprising a first component that includes:
(a) a binder consisting of carbohydrate polymer; said carbohydrate polymer comprising 5% to about 90% of the weight of binder solids;
(b) a carboxylated co-polymeric emulsion comprising styrene and an unsaturated diene;

said co-polymeric emulsion of styrene comprising 1% to about 40% of the weight of binder solids;
(c) a partially and/or fully hydrolyzed polyvinyl alcohol; said polyvinyl alcohol comprising 1% to about 10% of the weight of binder solids;
(d) urea comprising 2% to about 90% of the weight of binder solids; a second component that includes a crosslinking agent.

B1. A formaldehyde-free curable aqueous composition for bonding lignocellulosic material comprising a first component that includes:
(a) a binder consisting of carbohydrate polymer; said carbohydrate polymer comprising 5% to about 90% of the weight of binder solids;
(b) a carboxylated co-polymeric emulsion comprising styrene and an unsaturated diene; said co-polymeric emulsion of styrene comprising 1% to about 40% of the weight of binder solids;
(c) a partially and/or fully hydrolyzed polyvinyl alcohol; said polyvinyl alcohol comprising 1% to about 10% of the weight of binder solids;
(d) urea comprising 2% to about 90% of the weight of binder solids;
(e) a polyol comprising 0.5% to about 30% of the weight of binder solids;
(f) a defoamer comprising 0.1% to about 10% of the weight of binder solids;
(g) a release agent comprising 0.1% to about 10% of the weight of binder solids as the first part and a second component that includes
   a crosslinking agent.

C1. A formaldehyde-free curable aqueous composition for bonding lignocellulosic material comprising a first component that includes:
(a) a binder consisting of carbohydrate polymer; said carbohydrate polymer comprising 5% to about 90% of the weight of binder solids;
(b) a carboxylated co-polymeric emulsion comprising styrene and an unsaturated diene; said co-polymeric emulsion of styrene comprising 1% to about 40% of the weight of binder solids;
(c) a partially and/or fully hydrolyzed polyvinyl alcohol; said polyvinyl alcohol comprising 1% to about 10% of the weight of binder solids;
(d) urea comprising 2% to about 90% of the weight of binder solids;
(e) a polyol comprising 0.5% to about 30% of the weight of binder solids;
(f) a defoamer comprising 0.1% to about 10% of the weight of binder solids;
(g) a mono/poly carboxylic acid comprising 0.5% to about 20% of the weight of binder solids;
(h) alkali metal carboxylate comprising 0.5% to about 15% of the weight of binder solids;
(i) an alkali metal hydroxide comprising 0.1 to about 15% of the weight of the binder solids;
a release agent comprising 0.1% to about 10% of the weight of binder solids as the first part and a second component that includes
   a crosslinking agent.

C2. The curable aqueous composition of paragraph C1, wherein said carbohydrate polymer may be selected from the group consisting of monosaccharides, disaccharides, oligosaccharides and polysaccharides.

C3. The composite product of paragraph C1, wherein the lignocellulosic material is selected from the group consisting of particleboard, medium density fiberboard, high density fiberboard, oriented strand board, flake board and wafer board.

C4. The curable aqueous composition of paragraph C2, wherein the carbohydrate polymer is derived from the group consisting of corn, waxy corn, sugar cane, potatoes, sweet potatoes, rice, waxy rice, maize, wheat, barley and any combination thereof.

C5. The curable aqueous composition of paragraph C1, wherein the carbohydrate polymer has a dextrose equivalent (DE) number ranging between 2 and 20 inclusive.

C6. The curable aqueous composition of paragraph C1, wherein the carboxylated copolymeric emulsion of styrene is an emulsion of the copolymer of styrene and alkadienes.

C7. The curable aqueous composition of paragraph C6, wherein the alkadienes are selected from the group consisting of 1,3-butadiene, isoprene, 1,3-pentadiene, 1,3-hexadiene, 2,4-hexadiene, and 2-ethyl butadiene.

C8. The curable aqueous composition of paragraph C1, wherein the polyol is selected from the group consisting of ethylene glycol, polyethylene glycol, propylene glycol, polypropylene glycol, 1,4-butane diol, glycerol, 1,2-propanediol and 1,3-propanediol.

C9 The curable aqueous composition of paragraph C1, wherein the defoamer is selected from the group consisting of emulsions and/or dispersions of paraffin or naphthalene, emulsions and/or dispersions of polytrisiloxanes and particles made of precipitated silica.

C10. The curable aqueous composition of paragraph C1, wherein the carboxylic acid is selected from the group consisting of aliphatic monocarboxylic acid, aliphatic polycarboxylic acid, and aromatic carboxylic acids.

C11. The curable aqueous composition of paragraph C10, wherein the aliphatic monocarboxylic acid is selected from the group consisting of carbonic acid, methanoic acid, ethanoic acid, propanoic acid, butanoic acid, pentanoic acid, hexanoic acid, heptanoic acid, octanoic acid, nonanoic acid, decanoic acid, undecanoic acid, dodecanoic acid, tridecanoic acid, tetradecanoic acid, pentadecanoic acid, hexadecenoic acid, heptadecanoic acid, octadecanoic acid, nonadecanoic acid, eicosanoic acid and mixtures thereof.

C12. The curable aqueous composition of paragraph C10, wherein the aliphatic polycarboxylic acid is selected from the group consisting of tartaric acid, maleic acid, fumaric acid, malonic acid, succinic acid, malic acid, citric acid, oxalic acid, stearic acid and mixtures thereof.

C13. The curable aqueous composition of paragraph C10, wherein the aromatic carboxylic acid is selected from the group consisting of benzoic acid, salicylic acid, phenyl alkanoic acid, phthalic acid, isophthalic acid, terephthalic acid and mixtures thereof.

C14. The curable aqueous composition of paragraph C1, wherein the alkali metal carboxylates is selected from the group consisting of formate, acetate, lactate, oxalate, citrate of alkali metals and mixtures thereof.

C15. The curable aqueous composition of paragraph C1, wherein the alkali metal hydroxides are selected from the group consisting of lithium hydroxide, sodium hydroxide, potassium hydroxide, rubidium hydroxide, cesium hydroxide and mixtures thereof.

C16. The curable aqueous composition of paragraph C1, wherein the crosslinking agent is a formaldehyde-free crosslinking agent comprising poly-functional aromatic isocyanates.

C17. The curable aqueous composition of paragraph C10, wherein the polyfunctional aromatic isocyanates are polymeric methylene diphenyl diisocyanates.

C18. The curable aqueous composition of paragraph C11, wherein polymeric methylene diphenyl diisocyanates comprise 3% to 50% by weight of the binder composition.

D1. A composite product comprising a lignocellulosic material and a curable aqueous composition, wherein the curable aqueous composition comprises a first component that includes:
(a) a binder comprising a carbohydrate polymer, said carbohydrate polymer, comprising 5% to about 90% of the weight of binder solids;
(b) a co-polymeric emulsion comprising styrene and an acrylate moiety; said co-polymeric emulsion of styrene comprising 1% to about 40% of the weight of binder solids;
(c) a partially and/or fully hydrolyzed polyvinyl alcohol; said polyvinyl alcohol comprising 1% to about 10% of the weight of binder solids;
(d) urea comprising 2% to about 90% of the weight of binder solids;
(e) a polyol comprising 0.5% to about 30% of the weight of binder solids;
(f) a defoamer comprising 0.1% to about 10% of the weight of binder solids; and
(g) a release agent comprising 0.1% to about 10% of the weight of binder solids as the first part; and a second component that includes
   a crosslinking agent.

D2. The composite product of paragraph D1, wherein the carbohydrate polymer has a dextrose equivalent (DE) number from 2 to 20.

D3. The composite product of paragraph D1, wherein said carbohydrate polymer is selected from the group consisting of monosaccharides, disaccharides, oligosaccharides, and polysaccharides.

D4. The composite product of paragraph D3, wherein the carbohydrate polymer is derived from a plant source.

D5. The composite product of paragraph D4, wherein the plant source is selected from the group consisting of corn, waxy corn, sugar cane, potatoes, sweet potatoes, rice, waxy rice, maize, wheat, barley and any combination thereof.

D6. The composite product of paragraph D1, wherein the carbohydrate polymer may be present in an amount from about 5% to about 90% by weight of binder solids.

D7. The composite product of paragraph D1, wherein the co-polymeric emulsion is an emulsion of the copolymer of styrene and an acrylate moiety.

D8. The composite product of paragraph D7, wherein the acrylate moiety is selected from the group consisting of acrylic acid, methacrylic acid, methyl acrylate, methyl methacrylate, ethyl methacrylate, propyl acrylate, propyl methacrylate, n-butyl acrylate, n-butyl methacrylate, iso-butyl acrylate, iso-butyl-methacrylate, octyl methacrylate, alkyl acrylates, such as ethyl acrylate, methoxymethyl methacrylate, n-butoxyethyl methacrylate, and mixtures thereof.

D9 The composite product of paragraph D1, wherein the polyol is selected from the group consisting of ethylene glycol, polyethylene glycol, propylene glycol, polypropylene glycol, 1,4-butane diol, glycerol, 1,2-propanediol and 1,3-propanediol.

E1. A method for making a stable carbohydrate/urea dispersion, the method comprising:
(a) adding urea to water at 65-70° C.;
(b) dissolving urea in water and then adding carbohydrate at 35-40° C.; and (c)
   adding styrenic emulsion to form a stable carbohydrate/urea dispersion.

E2. The method of paragraph E1, wherein the styrenic emulsion is selected from the group consisting of carboxylated co-polymeric emulsion of styrene and butadiene and a non-carboxylated co-polymeric emulsion styrene and butadiene.

E3. The method of paragraph E1, wherein the styrenic emulsion is a noncarboxylated co-polymeric emulsion of styrene and acrylates.

E4. The method of paragraph E1, further comprising adding a crosslinking agent to the stable carbohydrate/urea dispersion.

E5. The method of paragraph E4, wherein the crosslinking agent is polymeric methylene diphenyl diisocyanates.

E6. The method of paragraph E5, wherein the polymeric methylene diphenyl diisocyanates is present in an amount from 3% to 50% by weight of the binder composition.

F1. A method of manufacturing a composite board comprising:
(a) adding the 2-part adhesive composition of any of paragraphs A1, B1, or C1 to lignocellulosic material and mixing for up to 10 minutes at room temperature;
(b) heating the mixture of adhesive and lignocellulosic material to 100° C. for 4 minutes; and
(c) compressing the mixture of adhesive and lignocellulosic materials to 500 psi at 100° C. for 4 minutes.

F2. The method of paragraph F, wherein the 2-part adhesive composition is a mixture of carbohydrate/urea dispersion and isocyanates.

F3. The method of paragraph F1, wherein the composite board is selected from the group consisting of particleboard, medium density fiberboard, high density fiberboard, oriented strand board, flake board, chip board and wafer board.

### Advantages, Features, Benefits

The presently disclosed formaldehyde-free aqueous binding compositions, their manufacture, and their use to prepare engineered composite products offer significant advantages over previously available formaldehyde-free adhesive systems for lignocellulosic materials.

The adhesive compositions prepared using the presently disclosed binding compositions exhibit much lower viscosities than previously used adhesives, making them ideal for product handling and transfer, as well as making them ideal for application by spraying. The binding compositions are substantially renewable and demonstrate excellent stabilities and improved resistance to microbial attack. The adhesive compositions prepared with the presently disclosed binding compositions exhibit improved water resistance properties and demonstrate significantly reduced sticking to metal surfaces when cured. The adhesive compositions prepared with the presently disclosed binding compositions impart improved pre-press tack properties to the resinated furnish/fiber which is essential for maintaining mat integrity. The novel compositions also exhibit much higher non-volatile content, which results in reduced water shipment during transportation. In addition, the higher non-volatile adhesive compositions provide greater latitude in the manufacture of composite wood products because of the presence of less water in the compositions.

Although the present invention has been shown and described with reference to the foregoing operational principles and preferred aspects, it will be apparent to those skilled in the art that various changes in form and detail may be made without departing from the spirit and scope of the invention. The present invention is intended to embrace all such alternatives, modifications and variances that fall within the scope of the appended claims.

It is believed that the disclosure set forth above encompasses multiple distinct inventions with independent utility. While each of these inventions has been disclosed in its preferred form, the specific aspects thereof as disclosed and illustrated herein are not to be considered in a limiting sense as numerous variations are possible. The subject matter of the inventions includes all novel and non-obvious combinations and sub combinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

Inventions embodied in various combinations and sub combinations of features, functions, elements, and/or properties may be claimed through presentation of new claims in a related application. Such new claims, whether they are directed to a different invention or directed to the same invention, whether different, broader, narrower or equal in scope to the original claims, are also regarded as included within the subject matter of the inventions of the present disclosure.

What is claimed is:

1. A curable aqueous composition, comprising:
a polysaccharide polymer, wherein the polysaccharide polymer comprises approximately 5% to 90% of a weight of binder solids;
a copolymeric emulsion comprising a styrene and an unsaturated diene, wherein the copolymeric emulsion of the styrene comprises 1% to 40% of the weight of binder solids;
a polyvinyl alcohol polymer, wherein the polyvinyl alcohol polymer comprises 1% to 10% by weight of binder solids; and
a blocked aldehyde, wherein the blocked aldehyde comprises 1% to 40% of the weight of polyvinyl alcohol in the curable aqueous composition.

2. The curable aqueous composition of claim 1, further comprising an ammonium salt, wherein the ammonium salt comprises any of ammonium chloride, ammonium sulfate, or ammonium nitrate, and wherein the ammonium salt is in an amount of 1% to 20% by weight of polyvinyl alcohol in the curable aqueous composition.

3. The curable aqueous composition of claim 1, wherein the polysaccharide polymer is selected from the group with dextrose equivalent ranging from 2 to 20.

4. The curable aqueous composition of claim 1, wherein the copolymeric emulsion of the styrene is an emulsion of a copolymer comprising the styrene and an alkadiene.

5. The curable aqueous composition of claim 4, wherein the alkadiene is selected from the group consisting of 1,3-butadiene, isoprene, 1,3-pentadiene, 1,3-hexadiene, 2,4-hexadiene and 2-ethyl butadiene.

6. The curable aqueous composition of claim 1, wherein polyvinyl alcohol polymer has weight average molecular weight in the range of 10,000 to 200,000.

7. The curable aqueous composition of claim 1, wherein polyvinyl alcohol polymer is selected from the group consisting of partially hydrolyzed polyvinyl alcohol and/or fully hydrolyzed polyvinyl alcohol.

8. The curable aqueous composition of claim 1, wherein the blocked aldehyde is selected from the group consisting of sodium bisulfite addition compound of glutaraldehyde and sodium bisulfite addition compound of glyoxal.

9. The curable aqueous composition of claim 1, further comprising a cross-linking agent, wherein the cross-linking agent comprises a polymeric poly-functional aromatic isocyanate.

10. The curable aqueous composition of claim 9, wherein the polymeric poly-functional aromatic isocyanate comprises a polymeric methylene diphenyl di-isocyanate or a polymeric toluene di-isocyanate.

11. The curable aqueous composition of claim 10, wherein the polymeric poly-functional aromatic isocyanate comprises 5% to 70% by weight of the curable aqueous composition.

12. The curable aqueous composition of claim 1, further comprising an aluminum salt, wherein the aluminum salt comprises any of aluminum chloride, aluminum sulfate, or aluminum nitrate, and wherein the aluminum salt is in an amount of 1% to 20% by weight of polyvinyl alcohol in the curable aqueous composition.

13. The curable aqueous composition of claim 1, further comprising an insecticide, wherein the insecticide is 0.1% to 10% of the weight of the curable aqueous composition.

14. A composite product, comprising:
a lignocellulosic material;
a binder comprising a polysaccharide polymer, wherein the polysaccharide polymer comprises approximately 5% to 90% of a weight of a binder solids;
a copolymeric emulsion comprising a styrene and an alkadiene, wherein the copolymeric emulsion of the styrene comprises approximately 1% to 40% of the weight of the binder solids;
a polyvinyl alcohol polymer, wherein the polyvinyl alcohol polymer is in an amount of 1% to 10% by weight of the binder solids; and
a blocked aldehyde, wherein the blocked aldehyde comprises 1% to 40% of the weight of polyvinyl alcohol in the binder solids.

15. The composite product of claim 14, wherein the lignocellulosic material is selected from the group consisting of wood particles, wood fibers, wood strands, wood flakes and wood chips.

16. The composite product of claim 14, wherein the copolymeric emulsion is an emulsion of a copolymer of the styrene and the alkadiene.

17. The composite product of claim 16, wherein the alkadiene is selected from the group consisting of 1,3-butadiene, isoprene, 1,3-pentadiene, 1,3-hexadiene, 2,4-hexadiene, and 2-ethyl butadiene.

18. A method for making an engineered wood product, comprising:
mixing at least one lignocellulosic material with an adhesive composition comprising:
a polysaccharide polymer, wherein the polysaccharide polymer comprises approximately 5% to 90% of a weight of a binder solids;
a copolymeric emulsion comprising a styrene and an unsaturated diene, wherein the copolymeric emulsion of the styrene comprises 1% to 40% of the weight of the binder solids;
a polyvinyl alcohol polymer, wherein the polyvinyl alcohol polymer comprises 1% to 10% by weight of the binder solids; and
a blocked aldehyde, wherein the blocked aldehyde comprises 1% to 40% of the weight of polyvinyl alcohol in the binder solids;
adding a polyisocyanate to the adhesive composition; and
compressing the adhesive composition and the at least one lignocellulosic material at room temperature to form a compressed mixture.

19. The method according to claim 18, further comprising heating the compressed mixture of adhesive and lignocellulosic material to 200° C. for up to 10 minutes under hydraulic pressure up to 1000 psi, forming an engineered composite board having a target thickness.

20. The method according to claim 19, wherein the engineered composite board is a particleboard, a medium density fiberboard, a high-density fiberboard, an oriented strand board, a flake board, a chip board or a wafer board.
